(19) United States
(12) Patent Application Publication
(10) Pub. No.: US 2025/0242322 A1
(43) Pub. Date: Jul. 31, 2025

(54) METHOD FOR RETROFITTING A HYDROGEN PRODUCTION UNIT

(71) Applicant: Johnson Matthey Public Limited Company, London (GB)

(72) Inventors: Kendra BRIGGS, Illinois, IL (US); Madhan JANARDHANAN, London (GB); Andrew JOHNSON, Cleveland (GB); Mark Andrew LINTHWAITE, Cleveland (GB); John David PACH, Cleveland (GB); Heather SMITH, Stockton-on-Tees (GB); Simon Nicholas TILLEY, Stockton-on-Tees (GB)

(21) Appl. No.: 18/686,730

(22) PCT Filed: Oct. 24, 2022
(86) PCT No.: PCT/GB2022/052702

§ 371 Date: Feb. 26, 2024

Related U.S. Application Data
(60) Provisional application No. 63/264,209, filed on Nov. 17, 2021.

(30) Foreign Application Priority Data
Dec. 6, 2021 (GB) 2117591.4

(51) Int. Cl. B01J 8/06; B01D 53/047; B01D 53/14; B01D 53/62; B01D 53/77; C01B 3/48; C01B 3/52; C01B 3/56; C01B 32/50

(52) U.S. Cl. CPC B01J 8/065; B01D 53/047; B01D 53/1418; B01D 53/1475; B01D 53/1493; B01D 53/62; B01D 53/77; B01J 8/062; C01B 3/48; C01B 3/52; C01B 3/56; C01B 32/50; B01D 2252/20489; B01D 2256/16; B01D 2257/504; B01J 2208/00194; B01J 2208/00504; B01J 2208/065; C01B 2203/0233; C01B 2203/0283; C01B 2203/0415; C01B 2203/042; C01B 2203/0475; C01B 2203/0822; C01B 2203/0833; C01B 2203/0883; C01B 2203/1241; C01B 2203/141; C01B 2203/148

(57) ABSTRACT

A method is described for retrofitting a hydrogen production unit, said hydrogen production unit having, a purification unit that separates the hydrogen-enriched gas into a hydrogen product stream and an off-gas stream, said method comprising the steps of: (a) installing a gas-heated reformer, and installing a carbon dioxide removal unit; (b) feeding a mixture of hydrocarbon and steam the gas-heated reformer, (c) combining the gas recovered with a second gas recovered and using the combined synthesis gas to heat reformer tubes in the gas-heated reformer; (d) recovering a cooled gas and passing the cooled gas to the water gas shift unit; (e) feeding the gas to the carbon dioxide removal unit to produce a carbon dioxide stream and a crude hydrogen stream, and; (f) passing the crude hydrogen stream to the purification unit. The invention further includes a process and system for producing hydrogen using the production unit.

This invention relates to methods for retrofitting hydrogen production units, in particular methods for retrofitting hydrogen production units comprising a fired steam reformer to reduce carbon dioxide emissions.

Hydrogen is conventionally produced from hydrocarbon feedstocks by steam reforming in large-scale fired steam reformers that generate carbon dioxide-containing flue gases at low pressure. The large volume and low pressure of the flue gases makes efficient capture of the carbon dioxide (CO₂) difficult. There is therefore a need for methods to adapt existing processes or provide new processes to reduce their carbon dioxide emissions and/or improve the efficiency of carbon capture from the process.

WO2010086635 (A1) discloses a process for producing hydrogen comprising the steps of: (i) passing a hydrocarbon feed though one or more purification sorbents to generate a purified hydrocarbon stream, (ii) combining steam with the purified hydrocarbon and passing the hydrocarbon/steam mixture adiabatically through a bed of steam reforming catalyst disposed in a pre-reformer vessel to generate a pre-reformed gas mixture, (iii) passing the pre-reformed gas mixture through externally-heated catalyst filled tubes in a fired steam reformer to generate a crude synthesis gas mixture comprising hydrogen, carbon monoxide, carbon dioxide and steam, (iv) passing the crude synthesis gas mixture through one or more beds of water-gas shift catalyst in one or more shift vessels to generate a shifted synthesis gas mixture, (v) passing the shifted synthesis gas mixture to a membrane shift reactor containing a bed of water-gas shift catalyst and a CO₂-selective membrane, in which the shifted synthesis gas mixture is subjected to the water-gas shift reaction over the water-gas shift catalyst, and carbon dioxide is separated from the shifted gas mixture by the membrane, thereby generating a hydrogen-enriched gas mixture, (vi) cooling the hydrogen-enriched gas mixture to below the dew point and separating off the condensate to generate a de-watered hydrogen-enriched gas mixture, (vii) passing the de-watered hydrogen-enriched gas mixture to one or more stages of CO₂ separation in pressure-swing absorption apparatus, to generate a pure hydrogen stream and a purge gas stream, and (viii) recycling at least a portion of the purge gas stream as fuel to the fired steam reformer or to the hydrocarbon feed or purified hydrocarbon feed streams. In one arrangement, a gas-heated reformer is combined with the fired steam reformer. Whereas the disclosed process contributes to a reduction in CO₂ emissions compared to a conventional flowsheet, there are still significant emissions from the flue gas, and there is no indication how an existing hydrogen production unit might be retrofitted to reduce its CO₂ emissions.

WO2011046680 (A1) discloses a method and apparatus for producing a hydrogen containing product in which hydrocarbon containing feed gas streams are reacted in a steam methane reformer of an existing hydrogen plant and a catalytic reactor that reacts hydrocarbons, oxygen and steam. The catalytic reactor is retrofitted to the existing hydrogen plant to increase hydrogen production. The resulting synthesis gas streams are combined, cooled, subjected to a water-gas shift step and then introduced into a production apparatus that can be a pressure swing adsorption unit. The amount of synthesis gas contained in the stream made available to the production apparatus is increased by virtue of the combination of the synthesis gas streams to increase production of the hydrogen containing product. The catalytic reactor is operated such that the synthesis gas stream produced by such reactor is similar to that produced by the steam methane reformer and at a temperature that will reduce oxygen consumption within the catalytic reactor. This retrofitting method may increase hydrogen production but does provide for reduced carbon dioxide emissions and more efficient carbon capture.

The Applicants have developed a method that more effectively provides for efficient carbon capture from existing hydrogen production units comprising fired steam reformers.

Accordingly, the invention provides a method for retrofitting a hydrogen production unit, said hydrogen production unit comprising, in series, a fired reformer containing a plurality of catalyst-containing reformer tubes fed with a mixture of hydrocarbon and steam and heated by combustion of a hydrocarbon fuel gas; a water gas shift unit fed with a synthesis gas recovered from the fired reformer that produces a hydrogen-enriched gas; and a purification unit that separates the hydrogen-enriched gas into a hydrogen product stream and an off-gas stream, said method comprising the steps of: (a) installing a gas-heated reformer in parallel to the fired reformer, and installing a carbon dioxide removal unit between the water-gas shift unit and the purification unit; (b) feeding a further portion of the mixture of hydrocarbon and steam to a plurality of catalyst-containing gas-heated reformer tubes in the gas-heated reformer, (c) combining the synthesis gas recovered from the fired reformer with a second synthesis gas recovered from the plurality of catalyst-containing gas-heated reformer tubes to form a combined synthesis gas mixture and using the combined synthesis gas mixture to heat the catalyst-containing gas-heated reformer tubes in a shell side of the gas-heated reformer; (d) recovering a partially cooled synthesis gas from the shell side of the gas-heated reformer and passing the partially cooled synthesis gas to the water gas shift unit; (e) feeding the hydrogen-enriched gas from the water-gas shift unit to the carbon dioxide removal unit to produce a carbon dioxide stream and a crude hydrogen stream; and (f passing at least a portion of the crude hydrogen stream to the purification unit to produce a purified hydrogen stream, wherein a portion of the crude hydrogen stream and/or a portion of the purified hydrogen stream are fed to the fired reformer in replacement of at least a portion of the hydrocarbon fuel gas.

The invention further includes a process for the production of hydrogen comprising the steps of: (a) feeding a mixture of hydrocarbon and steam to a plurality of catalyst-containing reformer tubes in fired reformer that are heated by combustion of a fuel; (b) in parallel, passing a further portion of the mixture of hydrocarbon and steam to a plurality of catalyst-containing gas-heated reformer tubes in a gas-heated reformer; (c) combining a synthesis gas recovered from the fired reformer with a second synthesis gas recovered from the catalyst-containing gas-heated reformer tubes to form a combined synthesis gas mixture and using the combined synthesis gas mixture to heat the catalyst-containing gas-heated reformer tubes in a shell side of the gas heated reformer; (d) recovering a partially cooled synthesis gas from the shell side of the gas heated reformer and passing the partially cooled synthesis gas to a water gas shift unit to produce a hydrogen-enriched gas; (e) passing the hydrogen-enriched gas to a carbon dioxide removal unit that removes carbon dioxide from the hydrogen-enriched gas to provide a crude hydrogen stream; and (f) passing at least portion of the crude hydrogen stream to a purification unit that separates the crude hydrogen into a purified hydrogen stream and an off-gas stream, wherein a portion of the crude hydrogen stream and/or a portion of the purified hydrogen stream is fed to the fired reformer as fuel for the combustion.

The invention further includes a system or plant for the production of hydrogen comprising: (a) a fired reformer containing a plurality of catalyst-containing reformer tubes that are heated by combustion of a fuel; (b) a gas-heated reformer containing a plurality of catalyst-containing gas-heated reformer tubes, said fired reformer and said gas-heated reformer being configured to be fed with a mixture of hydrocarbon and steam in parallel; (c) means for combining a synthesis gas recovered from the fired reformer with a second synthesis gas recovered from the catalyst-containing gas-heated reformer tubes to form a combined synthesis gas mixture, and for heating the catalyst-containing gas-heated reformer tubes in a shell side of the gas heated reformer using the combined synthesis gas mixture; (d) a water gas shift unit configured to receive a partially cooled synthesis gas from the shell side of the gas heated reformer and to produce a hydrogen-enriched gas; (e) a carbon dioxide removal unit configured to receive the hydrogen-enriched gas from the water-gas shift unit, remove carbon dioxide therefrom, and to provide a crude hydrogen stream; and (f) a purification unit configured to receive the crude hydrogen stream from the carbon dioxide removal unit and separate the crude hydrogen stream into a purified hydrogen stream and an off-gas stream, wherein the system further comprises means to feed a portion of the crude hydrogen stream and/or a portion of the purified hydrogen stream to the fired reformer as fuel for the combustion.

The Applicants have realised that the increased hydrogen production afforded by the gas-heated reformer installation is able to fuel the fired steam reformer and so dramatically reduce the CO₂ emissions. Furthermore, by installing a carbon dioxide removal unit, the invention provides means for removing carbon dioxide from the hydrogen-enriched gas in a relatively pure form for use in the production of chemicals or for carbon capture and storage. This also reduces the carbon dioxide content in the off-gas stream from the purification unit to very low levels such that it is more suitable for addition to the hydrocarbon feed to the steam reformers. Where the off-gas stream is used as feed to the reformers rather than as a fuel, CO₂ emissions from the existing hydrogen production unit may be virtually eliminated.

For retrofitting, the existing hydrogen production unit comprises, in series, a fired steam reformer containing a plurality of catalyst-containing reformer tubes fed with a mixture of hydrocarbon and steam and heated by combustion of a hydrocarbon fuel gas; a water gas shift unit fed with a synthesis gas recovered from the fired reformer that produces a hydrogen-enriched gas; and a purification unit that separates the hydrogen-enriched gas into a purified hydrogen product stream and an off-gas stream.

The existing hydrogen production unit is fed with a mixture of hydrocarbon and steam as the feed. In the present invention, the amount of this mixture is increased and divided between the fired steam reformer and an installed gas-heated reformer operated in parallel.

The hydrocarbon feed may comprise any gaseous or low boiling hydrocarbon, such as natural gas, associated gas, LPG, petroleum distillate, diesel, naphtha or mixtures thereof, or hydrocarbon-containing off-gases from chemical processes, such as a refinery off-gas or a pre-reformed gas. The gaseous mixture preferably comprises methane, associated gas or natural gas containing a substantial proportion, e.g. over 50% by volume methane. Natural gas is especially preferred. The hydrocarbon may be compressed to a pressure in the range 10-100 bar abs. The pressure of the hydrocarbon may usefully govern the pressure throughout the process. Operating pressure is preferably in the range 15-50 bar abs, more preferably 25-50 bar abs as this provides an enhanced performance from the process.

If required, the present invention may include installation of a hydrocarbon purification unit, comprising one or more stages to remove sulphur compounds, chloride compounds and heavy metals, upstream of the fired steam reformer and the gas-heated reformer. The hydrocarbon feed may contain sulphur compounds such as hydrogen sulphide, COS, CS₂ and mercaptans, and these are desirably removed by passing the hydrocarbon through a bed of a particulate sulphur sorbent such as ZnO and promoted ZnO materials, preferably at temperatures above 200° C., more preferably above 350° C. Hydrodesulphurisation catalysts such as Co/Mo, Ni/Mo on alumina may also be used upstream of the sulphur sorbent at temperatures in the range 200-400° C., preferably 350-400° C., to convert organosulphur compounds to H₂S using hydrogen present in, or added to, the hydrocarbon feed. An ultra-purification adsorbent may usefully be used downstream of the hydrogen sulphide adsorbent to further protect the steam reforming catalyst. Suitable, ultra-purification adsorbents may comprise copper-zinc oxide/alumina materials and copper-nickel-zinc oxide/alumina materials. The hydrocarbon feedstocks may also contain chloride compounds such as HCl and these are desirably removed upstream of the sulphur sorbent by passing the hydrocarbon through a bed of a particulate activated or alkalised alumina sorbent. The hydrocarbon feed may also contain heavy metals, such as mercury and arsenic, and these may be removed by passing the hydrocarbon, at temperatures preferably below 100° C., through a bed of particulate metal-sulphide, e.g. CuS, or a sulphided Cu/ZnO material. Mercury removal, if required is preferably accomplished upstream of sulphur and chloride removal.

The hydrocarbon is mixed with steam: this steam introduction may be performed by direct injection of steam and/or by saturation of the hydrocarbon feed by contact of the latter with a stream of heated water. In conventional plants the steam ratio is typically about 3 moles of steam per gram atom of hydrocarbon carbon in the feed. In the present invention, higher steam ratios up to 5 may be used, hence the steam ratio may be in the range of 2.6 to 5.0, and the method may include a step of increasing the steam ratio in the feed to the fired and gas heated reformers. In some arrangements, the steam to carbon ratio in the gas-heated reformer is greater than the steam to carbon ratio in the fired steam reformer. This provides additional process flexibility and reduces the risk of metal dusting in the gas-heated reformer.

Following installation of the parallel gas-heated reformer, the amount of the mixture of hydrocarbon and steam fed to the fired steam reformer may be the same or may be reduced depending on the size and capacity of the gas-heated reformer.

The present invention may include installation of a pre-reformer upstream of the fired steam reformer and the gas-heated reformer. If a pre-reformer is installed, then the hydrocarbon steam mixture may be fed to the inlet of a pre-reformer in which it is subjected to a step of adiabatic low temperature reforming. In such a process, the hydrocarbon/steam mixture is heated, typically to a temperature in the range 400-650° C., and then passed adiabatically through a bed of a suitable catalyst, usually a catalyst having a high nickel content, for example above 40% by weight. During such an adiabatic low temperature reforming step any hydrocarbons higher than methane react with steam to give a pre-reformed gas mixture of methane, steam, carbon oxides and hydrogen. The use of such an adiabatic reforming step, commonly termed pre-reforming, is desirable to ensure that the feed to the steam reformer contains no hydrocarbons higher than methane and also contains some hydrogen. This is desirable in order to minimise the risk of carbon formation on the catalyst in the steam reformer and gas-heated reformer. If a pre-reformer is installed the steam ratio may be lowered e.g. to about 2, e.g. 1.8-2.5, preferably 1.8-2.0. This has advantages in respect of providing lower operating costs, for example in steam generation. Hence the present invention may include lowering the steam to carbon ratio where a pre-reformer is installed.

The mixture of hydrocarbon and steam, or the pre-reformed gas mixture, may then be subjected to steam reforming by passing the gas mixture through a plurality of externally heated catalyst filled tubes in a fired steam reformer and a gas-heated reformer to generate a crude synthesis gas mixture comprising hydrogen, carbon monoxide, carbon dioxide and steam.

The fired steam reformer may be a conventional fired steam reformer in which the reformer tubes are arranged vertically and are heated by a combusting fuel. The steam reformer may be a top-fired steam reformer or a side-fired steam reformer. In such fired reformers the hot gas used to heat the tubes is provided by combusting a fuel gas using a plurality of burners disposed either adjacent the top end or along the length of the tubes. In top-fired or side-fired reformers, the burners are conventionally fed with a fuel gas mixture comprising a hydrocarbon, such as methane, or other suitable fuel gases. Combustion is performed using an oxidant such as air, which is also fed to the one or more burners to form the hot combustion gas. In the case of a top-fired reformer the inlets for the feed gas mixture are typically located at the top end of the reformer and the outlets for the reformed gas mixture at the bottom end. The burners are located at the top end and the combusted gas outlet is typically located at the bottom end. In the case of a side-fired reformer the inlets for the feed gas mixture are typically located at the top end of the reformer and the outlets for the reformed gas mixture at the bottom end. The burners in this case are located at multiple levels between the top end and the bottom end and the combusted gas outlet is typically located at the top end. The feed gas mixture may be passed to distribution means, such as header pipes which distribute the feed gas mixture to the tubes. Collector pipes may be connected to the bottom of the tubes, which provide channels for collection of the reformed gas.

Conventionally the fired reformer hydrocarbon fuel gas may comprise >50% by volume of methane. In the present invention, a portion of the increased crude hydrogen product stream and/or the purified hydrogen product stream is fed to the fired reformer in replacement of at least a portion of the hydrocarbon fuel gas. Accordingly, the fuel combusted to heat the tubes in the fired steam reformed is hydrogen rich, i.e., the fuel gas is preferably >75% by volume H₂, more preferably ≥90% by volume H₂, most preferably ≥95% by volume H₂. The hydrogen fuel may be either provided from a portion of the crude hydrogen stream recovered from the carbon dioxide removal unit or a portion of the purified hydrogen product recovered from the purification unit, or it may be a mixture of these. Whereas the CO₂ emissions by combustion are minimised by using only a portion of the purified hydrogen product stream, the use of pure hydrogen requires adjustment or potentially replacement of burners in the fired steam reformer and the heat energy generated by the combustion of hydrogen is different to that from conventional methane-rich fuel gases, which requires adjustment of the fuel and air flows. Moreover, increasing the production of the crude hydrogen product stream potentially requires increasing the capacity in the purification unit. Therefore, there are advantages by using a portion of the crude hydrogen product stream as a fuel for the fired steam reformer.

Combusting a portion of the hydrogen product gas would normally be seen as counter-intuitive, except that in the present invention, the uplift in capacity produced by the installation of the gas-heated reformer, combined with its low energy demand, enables the existing hydrogen production unit to satisfy the hydrogen demand from existing downstream processes and at the same time significantly reduce the CO₂ emissions. The gas-heated reformer is therefore desirably sized to provide essentially all of the hydrogen used as fuel in the fired steam reformer.

Fired steam reformers typically include one or more heat exchange coils for heating feeds and/or generating steam located in a flue gas-heated convection section of the reformer downstream of the zone in which the reformer tubes are located. The present invention should not require significant adjustment or re-configuration of these, but because the heat of combustion of hydrogen is different from conventional methane-based fuel gas, some adjustment of these may be desirable.

Adaptation of the burners in the fired steam reformer to use the hydrogen product as fuel may be required and may be accomplished in line with the manufacturer's instructions.

In addition to the adaptation of the fuel to the fired steam reformer, where one or more fired heaters are also used, e.g. to pre-heat feeds or generate steam for the process, the fuel for these may also be converted to include a portion of the hydrogen product gas recovered from the purification unit.

In the present invention, a gas-heated reformer is used to produce a second synthesis gas. The gas heated reformer typically has a tube side through which the reactants flow, and a shell side through which a heating medium is passed to heat the tubes. In the present invention, the heating medium used in the gas-heated reformer to heat the catalyst-filled reformer tubes is a combined synthesis gas formed from a synthesis gas recovered from the fired steam reformer and a second synthesis gas recovered from the catalyst-filled gas-heated reformer tubes. The tubes are heated by a hot gas passing around the tubes and therefore, unlike a fired reformer, the heating is primarily by convection. Any type of gas-heated reformer may be used. In one type of gas-heated reformer, the catalyst is disposed in tubes extending between a pair of tube sheets through a heat exchange zone. Reactants are fed to a zone above the upper tube sheet and pass through the tubes and into a zone beneath the lower tube sheet. The heating gas is passed through the zone between the two tube sheets. Gas-heated reformers of this type are described in GB 1578270, WO97/05947 and WO2010/049715A1. In the present invention, for this type of gas-heated reformer, the heating medium would be a combined synthesis gas mixture formed by mixing a synthesis gas recovered from the fired steam reformer with a second synthesis gas recovered from the zone beneath the lower tube sheet of the gas-heated reformer. Another type of gas-heated reformer that may be used is a single tube-sheet design, wherein the ends of the reformer tubes discharge synthesis gas into the shell side where it is combined with the heating medium. Gas heated reformers of this type are described in U.S. Pat. Nos. 5,362,454, 5,122,299 and 5,011,625. In the present invention, for this type of gas-heated reformer, the heating medium would be a combined synthesis gas mixture formed by mixing a synthesis gas recovered from the fired steam reformer with a second synthesis gas from beneath the tubes in the shell side of the gas-heated reformer. Another type of gas-heated reformer that may be used is a double-tube heat exchange reformer as described in U.S. Pat. No. 4,910,228 wherein the reformer tubes each comprise an outer tube having a closed end and an inner tube disposed concentrically within the outer tube and communicating with the annular space between the inner and outer tubes at the closed end of the outer tube, with the steam reforming catalyst disposed in said annular space. The external surface of the outer tubes is heated on a shell-side of the gas-heated reformer by a heating medium. The reactants are fed to the end of the outer tubes remote from said closed end so that the mixture passes through said annular space and undergoes steam reforming and then passes through the inner tube from which a reformed gas is recovered.

In the present invention, a combination of a fired reformer and a gas-heated reformer is used, wherein the mixture of hydrocarbon and steam, or a pre-reformed gas mixture, is split and a first portion fed to a fired steam reformer and a second portion fed to a gas heated reformer. The gas-heated reformer is heated by both synthesis gas collected from the tubes of the fired reformer and synthesis gas recovered from the tubes of the gas heated reformer. Accordingly, a mixing device may be installed to combine the synthesis gas streams recovered from the fired steam reformer and the gas-heated steam reformer and pass the combined synthesis gas as the heating medium to the shell-side of the gas-heated reformer.

The relative amount of the mixture of hydrocarbon and steam, or pre-reformed gas mixture, fed to the fired and gas-heated reformers may be varied to meet the hydrogen production required for downstream processes and also the heating needs of the fired steam reformer. For example, 5 to 40% vol of the total feedstock may be passed to the gas-heated reformer, preferably 10 to 30% vol.

The steam reforming catalyst used in the fired reformer and gas-heated reformer may be 10-30% wt nickel (expressed as NiO) supported on a refractory support such as a calcium aluminate cement, alumina, titania, magnesia, zirconia and the like. Alkali (e.g. potash)-promoted catalysts are desirable where there is a risk of carbon formation. The catalyst is typically supplied as supported NiO, which is reduced in-situ prior to operation. Alternatively, particularly when a low steam ratio is employed, a precious metal catalyst may be used.

Suitable precious metal catalysts include rhodium, ruthenium and platinum between 0.01 and 2% by weight on a suitable refractory support such as those used for nickel catalysts. Alternatively, a combination of a nickel and precious metal catalyst may be used. The steam reforming catalyst is normally in the form of shaped units, e.g. cylinders, rings, saddles, or cylinders having a plurality of through holes. Preferably the catalyst is in the form of lobed or fluted cylinders having a passage, or preferably more than one passage, extending longitudinally there-through, as this has been found to offer high catalyst activity combined with low pressure drop through the tubes. Alternatively, at least a portion of the steam reforming catalyst may include one or more structured catalyst units in the form of a ceramic or metal structure through which the reactants may flow in ordered, non-random directions, wash-coated with a layer of nickel and/or precious metal steam reforming catalyst. The invention therefore includes the option of replacing at least a portion of the existing steam reforming catalyst in the fired steam reformer with a structured steam reforming catalyst. Preferred structured steam reforming catalysts are described in US2012/0195801 A1.

During the steam reforming process, methane reacts with steam to produce hydrogen and carbon oxides. Any hydrocarbons containing two or more carbon atoms that are present are converted to methane, carbon monoxide and hydrogen, and in addition, water-gas shift reactions occur.

Steam reforming reactions take place in the tubes over the steam reforming catalyst at temperatures above 350° C. and typically the process fluid exiting the tubes is at a temperature in the range 650 to 950° C. The heat exchange medium flowing around the outside of the tubes in the fired steam reformer may have a temperature in the range 900 to 1300° C. Because the heating medium for the gas-heated reformer is the combined synthesis gas mixture, the heating medium temperature in the gas-heated reformer may be in the range 650 to 950° C. The combined synthesis gas is partially cooled when it gives up heat to drive the steam reforming reactions in the gas-heated reformer. The temperature of the partially cooled synthesis gas may be in the range 550 to 850° C.

It may be desirable to adjust the temperature of the partially cooled synthesis gas mixture upstream of the water gas shift unit. This may conveniently be done by raising steam and/or heating process feeds.

The partially cooled synthesis gas is fed to a water-gas shift unit, where it may be passed through one or more beds of water-gas shift catalyst in one or more shift vessels to generate a shifted synthesis gas mixture enriched in hydrogen. At the same time the water gas shift unit converts carbon monoxide in the synthesis gas to carbon dioxide. The reaction may be depicted as follows;

CO+H₂O⇄CO₂+H₂

Because steam reforming is performed with an excess of steam it is generally not necessary to add steam to the partially cooled synthesis gas mixture recovered from the gas-heated reformer to ensure sufficient steam is available for the water-gas shift reaction. However, supplemental steam may be added if desired.

The partially cooled synthesis gas may be subjected in the water-gas shift unit to one or more water-gas shift stages to form a hydrogen-enriched gas stream, or “shifted” gas stream. The one or more water-gas shift stages may include stages of high-temperature shift, medium-temperature shift, isothermal shift and low-temperature shift.

High-temperature shift may be operated adiabatically in a shift vessel at inlet temperatures in the range 300-400° C., preferably 320-360° C., over a bed of a reduced iron catalyst, such as chromia-promoted magnetite. Alternatively, a promoted zinc-aluminate catalyst may be used. A single stage of high-temperature shift may be used in the present invention. Alternatively, a combination of high-temperature and medium-temperature or low-temperature shift may be used.

Medium-temperature shift and low-temperature shift stages may be performed using shift vessels containing supported copper-catalysts, particularly copper/zinc oxide/alumina compositions. In low-temperature shift, a gas containing carbon monoxide (preferably <6% vol CO on a dry basis) and steam (at a steam to total dry gas molar ratio in range 0.3 to 1.5) may be passed over the catalyst in an adiabatic fixed bed with an outlet temperature in the range 200 to 300° C. The outlet carbon monoxide content may be in the range 0.1 to 1.5%, especially under 0.5% vol on a dry basis if additional steam is added. Alternatively, in medium-temperature shift, the gas containing carbon monoxide and steam may be fed to the catalyst at an inlet temperature in the range 200 to 240° C. although the inlet temperature may be as high as 280° C. The outlet temperature may be up to 300° C. but may be as high as 360° C.

Whereas one or more adiabatic water-gas shift stages may be employed, such as a high-temperature shift stage, optionally followed by a low-temperature shift stage, the partially cooled synthesis gas may be subjected to a stage of isothermal water-gas shift in a cooled shift vessel, optionally followed by one or more adiabatic medium- or low-temperature water-gas shift stages in un-cooled vessels as described above. The invention therefore may include replacing an adiabatic high temperature shift vessel containing an iron catalyst in the existing water gas shift unit with a cooled isothermal water gas shift vessel containing a copper catalyst. Using an isothermal shift stage, i.e. with heat exchange in the shift converter such that the exothermic reaction in the catalyst bed occurs in contact with heat exchange surfaces that remove heat, offers the potential to use the reformed gas stream in a very efficient manner. Whereas the term “isothermal” is used to describe a cooled shift converter, there may be a small increase in temperature of the gas between inlet and outlet, so that the temperature of the hydrogen-enriched reformed gas stream at the exit of the isothermal shift converter may be between 1 and 25 degrees Celsius higher than the inlet temperature. The coolant conveniently may be water under pressure such that partial, or complete, boiling takes place. The water can be in tubes surrounded by catalyst or vice versa. The resulting steam can be used, for example, to drive a turbine, e.g. for electrical power, or to provide process steam for supply to the process. In some embodiments, steam generated by the isothermal shift stage may be used to supplement the steam addition to the gaseous mixture comprising the hydrocarbon and steam upstream of the fired and gas-heated reformers. This improves the efficiency of the process and enables the relatively high steam to carbon ratio to be achieved at low cost.

In the present invention, enlargement of the water-gas shift unit to cater for the increased flow of synthesis gas generated by the combination of the fired steam reformer and gas-heated steam reformer may be accomplished by installation of one or more further water gas shift stages. For example, in some embodiments a low-temperature shift stage or an isothermal shift stage may be installed downstream of an existing high-temperature shift stage. Alternatively, one or more of the existing water-gas shift stages may be converted from axial flow to axial-radial, or radial flow, for example, as described in WO2015/107322 A1.

Following the one or more shift stages, the hydrogen-enriched gas is desirably cooled to a temperature below the dew point so that the steam condenses. The liquid water condensate may then be separated using one or more gas-liquid separators, which may have one or more further cooling stages between them. Any coolant may be used. Typically cooling of the hydrogen-enriched gas may be provided by boiling water under pressure coupled to a steam drum. If desired, cooling may be carried out in heat exchange with the process condensate. As a result, a stream of heated water, which may be used to supply some or all of the steam required for reforming, may be formed. Because the condensate may contain ammonia, methanol, hydrogen cyanide and CO₂, returning the condensate to form steam used in the reforming stage offers a useful way of returning hydrogen and carbon to the process.

One or more further stages of cooling are desirable. The cooling may be performed in heat exchange in one or more stages using demineralised water, air, or a combination of these. In a preferred embodiment, cooling is performed in heat exchange with one or more liquids in the CO₂ separation unit. One, two or three stages of condensate separation may be performed. Any condensate not used to generate steam may be sent to water treatment as effluent.

Typically, the hydrogen-enriched gas stream contains 10 to 30% vol of carbon dioxide (on a dry basis). In the present invention, after separation of the condensed water, carbon dioxide is separated from the resulting de-watered hydrogen-enriched gas stream.

Accordingly, a carbon dioxide removal unit may be installed between the water-gas shift unit and the purification unit.

The carbon dioxide removal unit may operate by means of a physical wash system or a reactive wash system, preferably a reactive wash system, especially an amine wash system. The carbon dioxide may be separated by an acid gas recovery (AGR) process. In the AGR process, the de-watered hydrogen-enriched reformed gas stream (i.e. the de-watered shifted gas) is contacted with a stream of a suitable absorbent liquid, such as an amine, for example monoethanolamine, diethanolamine, methyl diethanolamine and diglycolamine, particularly methyl diethanolamine (MDEA) solution so that the carbon dioxide is absorbed by the liquid to give a laden absorbent liquid and a gas stream having a decreased content of carbon dioxide. The laden absorbent liquid is then regenerated by heating, and/or reducing its pressure, to desorb the carbon dioxide and to give a regenerated absorbent liquid, which is then recycled to the carbon dioxide absorption stage. The heating may suitably be provided by steam, hot condensate or another suitable heating medium generated by the process. Alternatively, methanol or a glycol may be used to capture the carbon dioxide in a similar manner as the amine. If the carbon dioxide separation step is operated as a single pressure process, i.e. essentially the same pressure is employed in the absorption and regeneration steps, only a little recompression of the recycled carbon dioxide will be required. Carbon dioxide removal units of the types described above are commercially available.

If a carbon dioxide removal unit is already present in the existing process, either a supplemental unit may be installed in parallel, or the existing unit may be uprated in terms of solvent, operating conditions or efficiency.

The recovered carbon dioxide is relatively pure and so may be compressed and used for the manufacture of chemicals, purified for use in the food industry, or sent to storage or sequestration or used in enhanced oil recovery (EOR) processes. Compression may be accomplished using an electrically driven compressor powered by renewable electricity. In cases where the CO₂ is to be compressed for storage, transportation, use in EOR processes or conversion to other chemical products, the CO₂ may be first dried to prevent liquid water present in trace amounts, from condensing. For example, the CO₂ may be dried to a dew point ≤−10° C. by passing it through a bed of a suitable desiccant, such as a zeolite, or contacting it with a glycol in a glycol drying unit.

Upon the separation of the carbon dioxide, the process provides a crude hydrogen gas stream. The crude hydrogen stream may comprise 75-99% vol hydrogen, preferably 90-99% vol hydrogen, with the balance comprising one or more of methane, carbon monoxide, carbon dioxide and inert gases. The methane content of the crude hydrogen stream may be in the range 0.25-7.5% vol. The carbon monoxide content of the crude hydrogen stream may be in the range 0.5-7.5% vol. The carbon dioxide content of the crude hydrogen stream may be in the range 0.01-2.5% vol.

Whereas this hydrogen gas stream may be pure enough for many duties, in the present invention, the crude hydrogen gas stream is passed to a purification unit to provide a purified hydrogen product stream and an off-gas stream.

The purification unit may suitably comprise a membrane system, a temperature swing adsorption system, or a pressure swing adsorption system. The purification unit is preferably a pressure-swing adsorption unit. Such units comprise regenerable porous adsorbent materials that selectively trap gases other than hydrogen and thereby purify it. The purification unit produces a pure hydrogen stream preferably with a purity greater than 99.5% vol, more preferably greater than 99.9% vol. Such systems are commercially available. The purification unit also produces an off gas.

In the present invention, because carbon dioxide is removed by the carbon dioxide removal unit it may not be necessary to enlarge or adjust the operation of the purification unit. However, if desired, additional purification units may be installed in parallel to the existing purification unit, and/or the operating method for the existing purification unit may be adjusted to account for the reduction in carbon dioxide.

In the present invention, the crude and/or purified hydrogen stream is divided, and a portion used as fuel in the fired reformer. The invention therefore may include installing means for dividing the crude and/or purified hydrogen stream into a first portion, which is returned to the fired reformer as a fuel gas, and a second portion, which is used in downstream processes. In the present invention preferably essentially all of the additional crude and/or purified hydrogen generated by the gas-heated reformer is used as fuel in the fired steam reformer. In addition, depending on the relative sizes of the gas-heated reformer and the fired steam reformer, it may be desirable to use a portion, for example up to about 10% vol, of the crude and/or purified hydrogen generated by the fired steam reformer as fuel in the fired steam reformer. Whereas this may reduce the overall production from the hydrogen production unit, the significant lowering of CO₂ emissions provided by the invention remains very attractive.

The second portion of the purified hydrogen stream may be compressed and used in the existing downstream processes. The second portion of the pure hydrogen may be used in a downstream chemical synthesis process. For example, the second portion of the pure hydrogen stream may be used in a refinery for hydrotreating or hydrocracking processes. Alternatively, the second portion may be used to produce ammonia by reaction with nitrogen in an ammonia synthesis unit. Alternatively, the second portion of the pure hydrogen may be used with a carbon dioxide-containing gas to manufacture methanol in a methanol production unit. Alternatively, the second portion of the pure hydrogen may be used with a carbon-monoxide containing gas to synthesise hydrocarbons in a Fischer-Tropsch production unit. Any known ammonia, methanol or Fischer-Tropsch production technology may be used. Alternatively, the purified hydrogen product may be used in downstream power or heating process, e.g. by using it as fuel in a gas turbine (GT) or by injection into a domestic or industrial networked gas piping system. Compression of the purified hydrogen stream for any of the above uses may suitably be accomplished using an electrically driven compressor powered by renewable electricity.

If desired, a portion of the crude hydrogen or a portion of the second portion of the pure hydrogen may be compressed if necessary and recycled to the hydrocarbon feed for hydrodesulphurisation and to reduce the potential for carbon formation on the catalyst in the fired and gas-heated reformers.

The hydrogen purification unit desirably operates with continual separation of an off-gas from the crude hydrogen stream. The off-gas composition depends on the extent of the purification of the crude hydrogen stream. For example, the off-gas stream may comprise 30-65% vol hydrogen, with the balance comprising one or more of methane, carbon monoxide, carbon dioxide and potentially inert gases. The off-gas stream will typically comprise methane, which may be present as unreformed hydrocarbon in the feed or from conversion of longer chain hydrocarbons in the feed to methane. The methane content of the off-gas may be in the range 15-30% vol. The carbon monoxide content of the off-gas may be in the range 20-30% vol. The carbon dioxide content of the off-gas may be in the range 0-10% vol, preferably 0-2.5% vol.

If desired a cryogenic unit that uses partial condensation and distillation steps may be installed to separate liquid carbon dioxide and/or hydrogen from the off-gas. Such cryogenic units are commercially available.

In some embodiments, the entire off-gas may be combusted as fuel in the fired steam reformer in accordance with conventional practice. However, this contributes to CO₂ emissions from the production unit. Accordingly, in preferred embodiments, at least a portion of the off-gas, is returned to the process by adding it to the hydrocarbon feed, or the hydrocarbon and steam mixture, fed to the steam reformers. The portion of the off-gas may be added before or after any hydrocarbon purification stages. If the portion of the off-gas is added to the hydrocarbon feed upstream of purification, this may replace or partially replace purified hydrogen addition upstream of hydrodesulphurisation, which improves the hydrogen productivity. In some embodiments, the entire off-gas may be fed to the steam reformers, but if the off-gas contains inert gases such as nitrogen, argon or helium, then a small purge stream will desirably be used as fuel in the fired reformer to prevent their accumulation in the process. This will increase CO₂ emissions, therefore in such cases, the proportion of the off-gas used as fuel is preferably ≤10% by volume, more preferably ≤5% by volume, most preferably ≤1% by volume, of the off-gas.

The invention will be further illustrated by reference to the Figures in which;

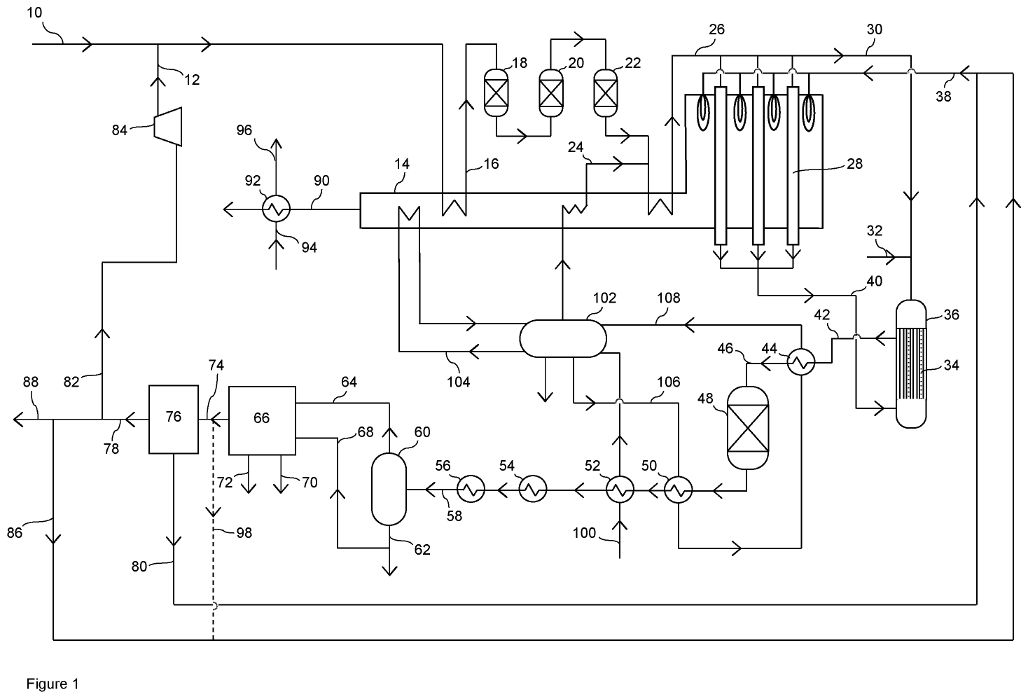

FIG. 1 is a flow sheet depicting a hydrogen production unit according to one embodiment of the invention comprising a fired steam reformer and an installed gas-heated reformer and carbon dioxide removal unit, with hydrogen product supplied as fuel for the fired steam reformer;

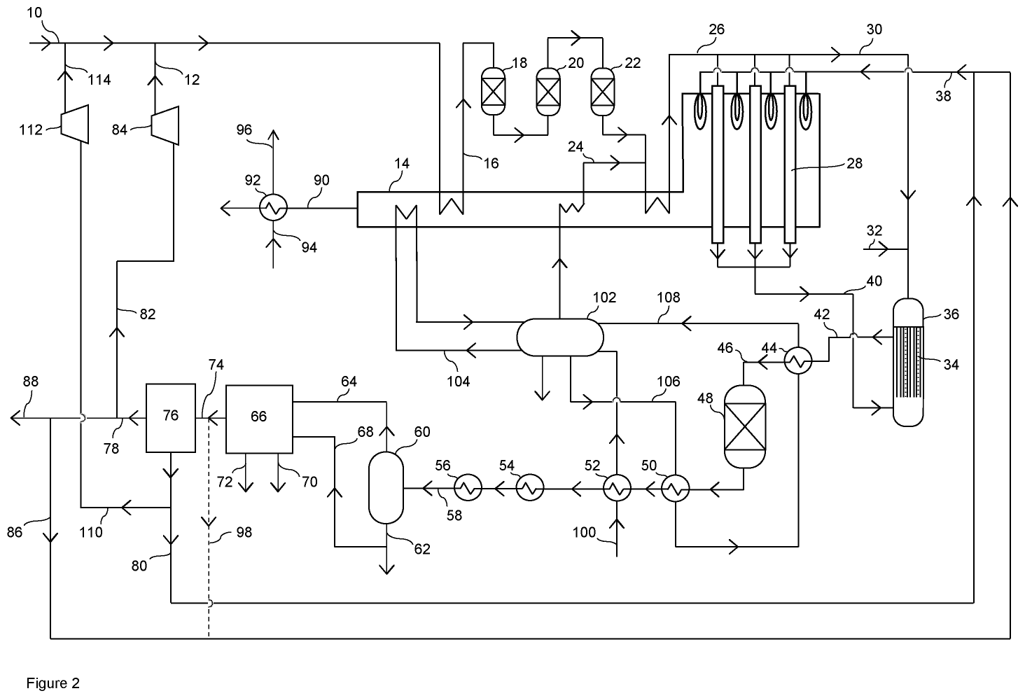

FIG. 2 is a flow sheet depicting a hydrogen production unit according to another embodiment of the invention comprising a fired steam reformer and an installed gas-heated reformer and carbon dioxide removal unit, with hydrogen product supplied as fuel for the fired steam reformer, and with off-gas from the purification unit supplied to the hydrocarbon feed; and

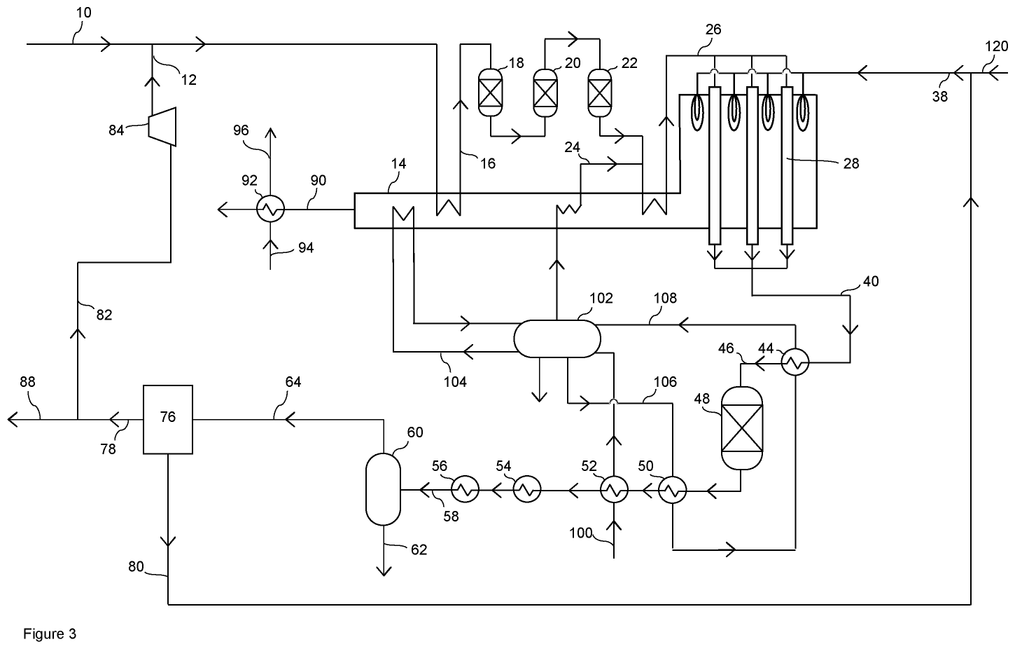

FIG. 3 is a comparative embodiment depicting a conventional hydrogen production unit comprising a fired steam reformer without a carbon dioxide removal unit or gas-heated reformer.

It will be understood by those skilled in the art that the drawings are diagrammatic and that further items of equipment such as reflux drums, pumps, vacuum pumps, temperature sensors, pressure sensors, pressure relief valves, control valves, flow controllers, level controllers, holding tanks, storage tanks, and the like may be required in a commercial plant. The provision of such ancillary items of equipment forms no part of the present invention and is in accordance with conventional chemical engineering practice.

In FIG. 1 a natural gas stream 10 is combined with a small amount of a compressed hydrogen stream 12 and the resulting mixture heated in the convection section of a fired steam reformer 14. The resulting heated gas mixture 16 is passed through a first purification vessel 18 containing a fixed bed of hydrodesulphurisation catalyst in which hydrogen in the feed is reacted with organic sulphur compounds therein to convert them to hydrogen sulphide. The resulting gas mixture is then passed through a second purification vessel 20 and a third purification vessel 22, each containing a bed of a hydrogen sulphide adsorbent that removes the sulphur compounds to form a desulphurised natural gas stream. The desulphurised natural gas stream recovered from vessel 22 is combined with superheated steam provided via line 24, and the resulting mixture of desulphurised natural gas and steam is heated in the convection section of the fired steam reformer 14. A first portion of the resulting pre-heated desulphurised natural gas and steam mixture is fed via line 26 to inlets of a plurality of externally heated catalyst-filled reformer tubes 28 in the fired steam reformer 14, and a second portion is fed via line 30, with optional additional steam supplied by line 32, to inlets of a plurality of externally heated catalyst-filled reformer tubes 34 in a gas-heated reformer 36. The plurality of catalyst-filled reformer tubes 28 in the fired steam reformer 14 are heated by combusting a fuel gas fed via line 38 in a radiant section of the fired reformer, located upstream of the convection section. Steam reforming reactions occur in the catalyst-filled reformer tubes 28, 34. A first crude synthesis gas 40 is recovered from outlets of the plurality of fired reformer tubes 28 and fed as a heating medium to a shell side of the gas heated reformer 36. The gas-heated reformer 36 is of a single tube-sheet design wherein a second synthesis gas mixture is discharged from the ends of the plurality of catalyst-filled tubes 34 into the shell side of the gas-heated reformer where mixes with the synthesis gas stream 40 recovered from the catalyst-filled tubes 28 of the fired reformer to form a combined synthesis gas, which then passes around the exterior of the tubes 34 as the heating medium. In consequence the combined synthesis gas is partially cooled. The cooled combined synthesis gas is recovered from the shell side of the gas heated reformer 36 via combined synthesis gas outlet and fed via line 42, to a heat exchanger 44 where it is further cooled and the resulting combined synthesis gas fed via line 46 to the inlet of a high-temperature shift vessel 48 containing a fixed bed of high temperature shift catalyst. The water-gas shift reactions occur over the high-temperature shift catalyst, forming a hydrogen enriched gas. The hydrogen enriched gas is recovered from the water gas shift vessel 48 and cooled in heat exchange with medium-pressure steam in heat exchanger 50, then boiler feed water in heat exchanger 52, and then water in heat exchangers 54 and 56 that cool the hydrogen-enriched gas to below the dew point such that a condensate is formed. The resulting mixture is fed from heat exchanger 56 via line 58 to a gas-liquid separator 60. The condensate is recovered from the gas-liquid separator 60 via line 62. The resulting de-watered hydrogen-enriched gas is fed via line 64 to a carbon dioxide removal unit 66 that uses an amine wash solution to recover carbon dioxide from the de-watered hydrogen-enriched gas. The carbon dioxide removal unit 66 uses a portion 68 of the condensate to heat and desorb carbon dioxide from the amine wash solution in a regeneration unit within the carbon dioxide removal unit. Water is recovered from the carbon dioxide removal unit 66 via line 70 and may be used for steam generation within the process. A carbon dioxide stream is recovered from the carbon dioxide removal unit 66 via line 72. The carbon dioxide stream 72 may be dried, purified and compressed for storage or for the synthesis of useful products (not shown). A crude hydrogen product is recovered from the carbon dioxide removal unit 66 and fed via line 74 to a purification unit 76 comprising a pressure-swing absorption vessel containing a sorbent. The pressure-swing absorption vessel produces a purified hydrogen product, which is recovered from the purification unit 76 via line 78. The purification unit also provides an off-gas stream, which is fed via line 80 to form part of the fuel gas stream 38 combusted in the fired steam reformer 14. A portion of the purified hydrogen product may be fed from line 78 via line 82 to compressor 84 where it is compressed to provide the hydrogen stream 12 added to the natural gas feed 10. A further portion of the purified hydrogen product is fed via line 86 to form the remainder of the fuel gas stream 38 combusted in the fired steam reformer 14. A remaining portion of the purified hydrogen product is exported via line 88 for use downstream. Flue gas from the fired steam reformer 14 is recovered from the convection section via line 90 and cooled in heat exchanger 92 before being vented to atmosphere. Heat exchanger 92 is used to heat combustion air 94, which is fed from heat exchanger 92 via line 96 to combust the fuel gas in stream 38 in the radiant section of the fired steam reformer.

It will be understood that while this embodiment uses a portion of the purified hydrogen stream 78 via line 86 as a fuel in the fired steam reformer 14, it is possible to use a portion of the crude hydrogen product from line 74 as a fuel. This is depicted as dashed line 98.

Boiler feed water 100 is heated in heat exchanger 52 and passed to a steam drum 102 that provides steam for the process. The steam drum 102 has a steam boiler circuit 104 heated by the flue gas in the convection section of the fired steam reformer 14. The steam drum 102 also provides a hot water stream 106 used to cool the hydrogen-enriched gas in heat exchanger 50 and the crude synthesis gas in heat exchanger 46 before being returned to the steam drum 102 via line 108.

In FIG. 2, the process is as depicted in FIG. 1, except that a portion of the off-gas stream 80 is taken via line 110, compressed in compressor 112 and added via line 114 to the natural gas feed in line 10. In this arrangement, because the off-gas contains hydrogen, it is not necessary feed a portion of the purified hydrogen from line 78 via line 82 and compressor 84 to the natural gas. Alternatively, it is possible to retain line 82 and compressor 84 but feed the off-gas via line 110 and compressor 112 to the reformer feed downstream of the vessel 22, for example before or after addition of steam via line 24. Alternatively, a portion of the de-watered hydrogen-enriched gas from line 64, or a portion of the crude synthesis gas 74 may be used to provide the hydrogen for the purification.

In FIG. 3, the process is as depicted in FIG. 1, but the gas-heated reformer 36 and carbon dioxide removal unit 66 are not present. Accordingly, all of the hydrocarbon and steam mixture 26 is fed to the plurality of tubes 28 in the fired steam reformer 14 and the crude synthesis gas stream 40 from the fired steam reformer 14 is directed to the heat exchanger 44 and the water gas shift vessel 48. In this arrangement, a portion of the hydrogen product stream is not used as fuel for the fired steam reformer and accordingly all of the off gas from the purification unit 76 is directed via line 80 to the fired steam reformer as fuel. The offgas in line 80 is supplemented by the combustion of a natural gas fuel fed via line 120 in order to provide the heat for the steam reforming reaction.

The invention is further illustrated by reference to the following calculated Examples.

The process of FIGS. 1 and 2 were modelled based on a natural gas feed and fuel to illustrate the achievable reductions in CO₂ emissions. A comparative example based on FIG. 3, was also modelled. The results for FIG. 2 were as follows:

| Stream Number | | 10 | 12 | 16 | 24 | 26 | 30 |
|---|---|---|---|---|---|---|---|
| Temperature | ° C. | 40 | 100 | 380 | 411 | 550 | 550 |
| Pressure | bar a | 28.5 | 30.0 | 27.0 | 26.3 | 24.8 | 24.8 |
| Mass Flow | tonne/h | 35.00 | 0 | 58.51 | 135.8 | 194.3 | 33.03 |
| Vapour Flow | Nm³/h | 45890 | 0 | 91450 | 169000 | 260400 | 44270 |
| Molecular Weight | | 17.09 | 2.02 | 14.34 | 18.02 | 16.72 | 16.72 |
| Composition | mol % | | | | | | |
| Water | | — | — | 0.25 | 100.00 | 64.97 | 64.97 |
| Hydrogen | | — | 100.00 | 26.61 | — | 9.35 | 9.35 |
| Carbon Monoxide | | — | — | 12.37 | — | 4.35 | 4.35 |
| Carbon Dioxide | | 0.50 | — | 0.31 | — | 0.11 | 0.11 |
| Nitrogen | | — | — | — | — | — | — |
| Methane | | 95.00 | — | 58.19 | — | 20.44 | 20.44 |
| Ethane | | 3.00 | — | 1.51 | — | 0.53 | 0.53 |
| Propane | | 1.00 | — | 0.50 | — | 0.18 | 0.18 |
| Butane | | 0.50 | — | 0.25 | — | 0.09 | 0.09 |
| Oxygen | | — | — | — | — | — | — |
| Heavies | | — | — | — | — | — | — |

| Stream Number | | 32 | 40 | 42 | 58 | 64 | 74 |
|---|---|---|---|---|---|---|---|
| Temperature | ° C. | 420 | 880 | 671 | 40 | 40 | 40 |
| Pressure | bar a | 39.2 | 22.0 | 21.3 | 19.3 | 19.3 | 19.2 |
| Mass Flow | tonne/h | 20.61 | 161.3 | 215.2 | 215.2 | 136.2 | 41.64 |
| Vapour Flow | Nm³/h | 25650 | 296300 | 382900 | | 284700 | 235800 |
| Molecular Weight | | 18.02 | 12.20 | 12.60 | 12.6 | 10.72 | 3.96 |
| Composition | mol % | | | | | | |
| Water | | 100.00 | 28.80 | 32.99 | 25.93 | 0.41 | 0.10 |
| Hydrogen | | — | 51.63 | 48.74 | 55.80 | 75.05 | 90.53 |
| Carbon Monoxide | | — | 11.61 | 10.18 | 3.11 | 4.18 | 5.05 |
| Carbon Dioxide | | — | 5.16 | 5.45 | 12.51 | 16.80 | 0.02 |
| Nitrogen | | — | — | — | — | — | — |
| Methane | | — | 2.80 | 2.65 | 2.65 | 3.56 | 4.29 |
| Ethane | | — | — | — | — | — | — |
| Propane | | — | — | — | — | — | — |
| Butane | | — | — | — | — | — | — |
| Oxygen | | — | — | — | — | — | — |
| Heavies | | — | — | — | — | — | — |

| Stream Number | | 78 | 80 | 86 | 88 | 90 | 112 |
|---|---|---|---|---|---|---|---|
| Temperature | ° C. | 40 | 40 | 40 | 40 | 397 | 485 |
| Pressure | bar a | 18.9 | 1.70 | 18.9 | 18.9 | 0.96 | 28.5 |
| Mass Flow | tonne/h | 10.83 | 1.238 | 6.073 | 10.83 | 246.0 | 23.51 |
| Vapour Flow | Nm³/h | 187920 | 2400 | 67520 | 120400 | 220700 | 45560 |
| Molecular Weight | | 2.02 | 11.57 | 2.02 | 2.02 | 24.98 | 11.57 |
| Composition | mol % | | | | | | |
| Water | | — | 0.51 | — | — | 31.64 | 0.51 |
| Hydrogen | | 100.00 | 53.42 | 100.00 | 100.00 | — | 53.42 |
| Carbon Monoxide | | — | 24.84 | — | — | — | 24.84 |
| Carbon Dioxide | | — | 0.12 | — | — | 0.50 | 0.12 |
| Nitrogen | | — | — | — | — | 66.57 | — |
| Methane | | — | 21.11 | — | — | — | 21.11 |
| Ethane | | — | — | — | — | — | — |
| Propane | | — | — | — | — | — | — |
| Butane | | — | — | — | — | — | — |
| Oxygen | | — | — | — | — | 1.29 | — |
| Heavies | | — | — | — | — | — | — |

In comparison, the results for FIG. 3 were as follows:

| Stream Number | | 10 | 26 | 80 | 88 | 90 | 120 |
|---|---|---|---|---|---|---|---|
| Temperature | ° C. | 40 | 550 | 40 | 40 | 372 | 40 |
| Pressure | bar a | 28.5 | 24.8 | 1.70 | 19.9 | 0.96 | 2.25 |
| Mass Flow | tonne/h | 34.21 | 145.2 | 81.88 | 12.14 | 415.1 | 8.213 |
| Vapour Flow | Nm³/h | 44860 | 184200 | 67120 | 135000 | 317000 | 10770 |
| Molecular Weight | | 17.09 | 17.67 | 27.34 | 2.02 | 29.35 | 17.09 |
| Composition | mol % | | | | | | |
| Water | | — | 74.88 | 1.20 | — | 16.99 | — |
| Hydrogen | | — | 0.76 | 27.71 | 100.00 | — | — |
| Carbon Monoxide | | — | — | 13.43 | — | — | — |
| Carbon Dioxide | | 0.50 | 0.12 | 48.46 | — | 18.67 | 0.50 |
| Nitrogen | | — | — | — | — | 63.11 | — |
| Methane | | 95.00 | 23.14 | 9.20 | — | — | 95.00 |
| Ethane | | 3.00 | 0.73 | — | — | — | 3.00 |
| Propane | | 1.00 | 0.24 | — | — | — | 1.00 |
| Butane | | 0.50 | 0.12 | — | — | — | 0.50 |
| Oxygen | | — | — | — | — | 1.23 | — |
| Heavies | | — | — | — | — | — | — |

The processes of FIGS. 1, 2 and 3 may be compared in terms of fuel demand and CO₂ efficiency. The results were as follows:

| | NG Feed | H₂ Product | NG Fuel | CO₂ Captured | CO₂ Released | CO₂ Captured |
|---|---|---|---|---|---|---|
| Case | Nm³/h | Nm³/h | Nm³/h | tonne/h | tonne/h | % |
| FIG. 1 | 54090 | 148700 | 0 | 79.85 | 33.09 | 70.7 |
| FIG. 2 | 45890 | 120400 | 0 | 93.79 | 2.17 | 97.7 |
| FIG. 3 | 44860 | 135000 | 10770 | 0 | 116.00 | 0 |

Whereas the process of FIG. 1 provides about 70% CO₂ capture with an increased hydrogen productivity compared to the comparative process depicted in FIG. 3, FIG. 2, with off-gas recycle provides over 97% CO₂ capture with only a small drop in hydrogen production.

1. A method for retrofitting a hydrogen production unit, said hydrogen production unit comprising, in series,
a fired reformer containing a plurality of catalyst-containing reformer tubes fed with a mixture of hydrocarbon and steam and heated by combustion of a hydrocarbon fuel gas;
a water gas shift unit fed with a synthesis gas recovered from the fired reformer that produces a hydrogen-enriched gas; and
a purification unit that separates the hydrogen-enriched gas into a hydrogen product stream and an off-gas stream, said method comprising the steps of:
(a) installing a gas-heated reformer in parallel to the fired reformer, and installing a carbon dioxide removal unit between the water-gas shift unit and the purification unit;
(b) feeding a further portion of the mixture of hydrocarbon and steam to a plurality of catalyst-containing gas-heated reformer tubes in the gas-heated reformer,
(c) combining the synthesis gas recovered from the fired reformer with a second synthesis gas recovered from the plurality of catalyst-containing gas-heated reformer tubes to form a combined synthesis gas mixture and using the combined synthesis gas mixture to heat the catalyst-containing gas-heated reformer tubes in a shell side of the gas-heated reformer;
(d) recovering a partially cooled synthesis gas from the shell side of the gas-heated reformer and passing the partially cooled synthesis gas to the water gas shift unit;
(e) feeding the hydrogen-enriched gas from the water-gas shift unit to the carbon dioxide removal unit to produce a carbon dioxide stream and a crude hydrogen stream, and;
(f) passing at least a portion of the crude hydrogen stream to the purification unit to produce a purified hydrogen stream, wherein a portion of the crude hydrogen stream and/or a portion of the purified hydrogen stream are fed to the fired reformer in replacement of at least a portion of the hydrocarbon fuel gas.

2. The method according to claim 1, wherein the hydrocarbon in the mixture of hydrocarbon and steam comprises more than 50% by volume methane and prior to the retrofit, the hydrocarbon fuel gas comprises more than 50% by volume methane.

3. The method according to claim 1, wherein the hydrocarbon in the mixture of hydrocarbon and steam comprises natural gas, associated gas, LPG, petroleum distillate, diesel, naphtha or mixtures thereof, a refinery off-gas, or a pre-reformed gas.

4. The method according to claim 1, wherein the hydrocarbon fuel gas comprises natural gas.

5. The method according to claim 1, wherein a portion of the crude hydrogen stream and a portion of the purified hydrogen stream are fed to the fired reformer in replacement of at least a portion of the hydrocarbon fuel gas.

6. The method according to claim 1, wherein the gas-heated reformer is sized to provide essentially all of the hydrogen used as fuel in the fired steam reformer.

7. The method according to claim 1, wherein an adiabatic high temperature shift vessel containing an iron catalyst in the existing water gas shift unit is replaced with a cooled isothermal water gas shift vessel containing a copper catalyst.

8. The method according to claim 1, wherein the carbon dioxide removal unit operates by means of a physical wash system or a reactive wash system, preferably a reactive wash system, especially an amine wash system.

9. The method according to claim 1 wherein the purification unit operates by pressure swing adsorption and/or temperature swing adsorption.

10. The method according to claim 1, wherein at least a portion of the off-gas, stream is added to the hydrocarbon or the hydrocarbon and steam mixture fed to the steam reformers.

11. A process for the production of hydrogen comprising the steps of:
(a) feeding a mixture of hydrocarbon and steam to a plurality of catalyst-containing reformer tubes in fired reformer that are heated by combustion of a fuel;
(b) in parallel, passing a further portion of the mixture of hydrocarbon and steam to a plurality of catalyst-containing gas-heated reformer tubes in a gas-heated reformer;
(c) combining a synthesis gas recovered from the fired reformer with a second synthesis gas recovered from the catalyst-containing gas-heated reformer tubes to form a combined synthesis gas mixture and using the combined synthesis gas mixture to heat the catalyst-containing gas-heated reformer tubes in a shell side of the gas heated reformer;
(d) recovering a partially cooled synthesis gas from the shell side of the gas heated reformer and passing the partially cooled synthesis gas to a water gas shift unit to produce a hydrogen-enriched gas;
(e) passing the hydrogen-enriched gas to a carbon dioxide removal unit that removes carbon dioxide from the hydrogen-enriched gas to provide a crude hydrogen stream; and
(f) passing at least portion of the crude hydrogen stream to a purification unit that separates the crude hydrogen into a purified hydrogen stream and an off-gas stream, wherein a portion of the crude hydrogen stream and/or a portion of the purified hydrogen stream is fed to the fired reformer as fuel for the combustion.

12. The process recited in claim 11, wherein a portion of the crude hydrogen stream and a portion of the purified hydrogen stream are fed to the fired reformer as fuel for the combustion.

13. The process in claim 11, wherein the hydrocarbon in the mixture of hydrocarbon and steam comprises more than 50% by volume methane and the fuel for the combustion in the fired reformer comprises at least 75% vol H2, preferably at least 90% by volume H2, most preferably at least 95% by volume H2.

14. The process recited in claim 11, wherein the hydrocarbon in the mixture of hydrocarbon and steam comprises natural gas, associated gas, LPG, petroleum distillate, diesel, naphtha or mixtures thereof, a refinery off-gas, or a pre-reformed gas.

15. The process recited in claim 11, wherein the mixture of hydrocarbon and steam fed to the gas-heated reformer has a steam to carbon ratio that is greater than the steam to carbon ratio of the mixture of hydrocarbon and steam fed to the fired steam reformer.

16. The process recited in claim 11, wherein, carbon dioxide recovered from the carbon dioxide removal unit is compressed and used for the manufacture of chemicals, purified for use in the food industry, or sent to storage or sequestration or used in enhanced oil recovery processes.

17. The process recited in claim 11, wherein at least a portion of the off-gas, stream is added to the hydrocarbon or the hydrocarbon and steam mixture fed to the steam reformers.

18. A system or plant for the production of hydrogen comprising:
(a) a fired reformer containing a plurality of catalyst-containing reformer tubes that are heated by combustion of a fuel;
(b) a gas-heated reformer containing a plurality of catalyst-containing gas-heated reformer tubes, said fired reformer and said gas-heated reformer being configured to be fed with a mixture of hydrocarbon and steam in parallel;
(c) means for combining a synthesis gas recovered from the fired reformer with a second synthesis gas recovered from the catalyst-containing gas-heated reformer tubes to form a combined synthesis gas mixture, and for heating the catalyst-containing gas-heated reformer tubes in a shell side of the gas heated reformer using the combined synthesis gas mixture;
(d) a water gas shift unit configured to receive a partially cooled synthesis gas from the shell side of the gas heated reformer and to produce a hydrogen-enriched gas;
(e) a carbon dioxide removal unit configured to receive the hydrogen-enriched gas from the water-gas shift unit, remove carbon dioxide therefrom, and to provide a crude hydrogen stream; and,
(f) a purification unit configured to receive the crude hydrogen stream from the carbon dioxide removal unit and separate the crude hydrogen stream into a purified hydrogen stream and an off-gas stream, wherein the system further comprises means to feed a portion of the crude hydrogen stream and/or a portion of the purified hydrogen stream to the fired reformer as fuel for the combustion.
